(19) United States
(12) Patent Application Publication
(10) Pub. No.: US 2026/0357155 A1
(43) Pub. Date: Nov. 12, 2026

(54) Solid Unit Dose Detergent Composition

(71) Applicant: RECKITT BENCKISER FINISH B.V., Hoofddorp (NL)

(72) Inventors: Souhila AISSANI, Heidelberg (DE); Alias AL-BAYATI, Heidelberg (DE); Torsten ROTH, Heidelberg (DE); Cyrus SAFDAR, Heidelberg (DE); Claudia SCHMAELZLE, Heidelberg (DE); Hanqing WANG, Heidelberg (DE)

(21) Appl. No.: 19/130,760

(22) PCT Filed: Dec. 12, 2023
(86) PCT No.: PCT/EP2023/085366

§ 371 Date: May 16, 2025

(30) Foreign Application Priority Data
Dec. 14, 2022 (GB) 2218868.4

(51) Int. Cl. C11D 3/22; C11D 3/43; C11D 11/00; C11D 17/00

(52) U.S. Cl. CPC C11D 3/228; C11D 3/43; C11D 11/00; C11D 17/0065

(57) ABSTRACT

The present invention relates to a solid unit dose detergent composition comprising 0.1 wt. % to 30 wt. % of at least one lignosulphonate, based on the total weight of the composition, and a disintegrant. It also relates to a method of forming the solid unit dose detergent composition. The invention further relates to the use of lignosulphonate as a processing aid in a solid unit dose detergent composition or/and as a processing aid in a solid unit dose detergent composition to improve the disintegration time of the composition.

The present invention relates to solid unit dose detergent compositions comprising lignosulphonates and a disintegrant, methods of forming the same and to the use of lignosulphonate in solid unit dose detergent formulations.

Solid detergent compositions and products are well known. It may be advantageous to provide solid detergent compositions in a unit dose or mono-dose form. So-called “mono-dose” detergent products are convenient for consumers since there is no need to measure out the required volume of detergent each time. Various unit dose formats, including tablets, and containers made of water-soluble material, are already known.

Tabletting of detergent compositions generally requires the use of various processing aids in order to provide the necessary physical properties in the product. It is known to use polyethylene glycol (PEG) as processing aid and binder. However, PEG is expensive relative to the other ingredients of detergent compositions and is generally derived from petrochemical resources. Accordingly, there is a need to find alternative processing aids for use in detergent compositions which are cheaper and more environmentally friendly or sustainable whilst achieving the required friability, disintegration time and hardness when used in solid unit dose detergent compositions.

In a first aspect the present invention provides a solid unit dose detergent composition comprising at least one lignosulphonate in an amount of from 0.1 wt. % to 30 wt. % based on the total weight of the composition, and a disintegrant.

Preferably the composition is a dishwashing detergent composition or a laundry detergent composition, preferably wherein the composition is an automatic dishwashing detergent composition.

The at least one lignosulphonate may be selected from the group consisting of ammonium lignosulphonate, sodium lignosulphonate, calcium lignosulphonate, magnesium lignosulphonate and combinations thereof; preferably the at least one lignosulphonate is a sodium lignosulphonate.

The at least one lignosulphonate may be present in an amount of from 0.1 wt. % to 15 wt. %, based on the total weight of the composition, preferably 0.1 wt. % to 10 wt. %, more preferably 0.5 wt. % to 5 wt. %, even more preferably 1 wt. % to 3 wt. %. In some embodiments, the at least one lignosulphonate may be present in an amount of from 0.1 wt. % to 15 wt. %, 0.1 wt. % to 10 wt. %, 0.1 wt. % to 5 wt. %, or 0.1 wt. % to 3 wt. %.

Preferably the solid unit dose detergent composition is in the form of a pill, tablet or briquette, or forms at least one layer or portion of a multilayer pill, tablet or briquette.

The composition may further comprise:
a source of alkalinity, preferably in an amount of from 1 wt. % to 80 wt. %, based on the total weight of the composition, and/or
a builder, preferably in an amount of from 0.1 wt. % to 20 wt. %, based on the total weight of the composition.

The composition may comprise the disintegrant in an amount of from 0.1 wt. % to 50 wt. %, based on the total weight of the composition, preferably between 4 wt. % to 40 wt. %, more preferably between 10 wt. % and 30 wt. %, even more preferably between 20 wt. % and 30 wt. %; wherein preferably said disintegrant is selected from the group consisting of cellulose, crosslinked polymers including polyvinylpyrrolidone and carboxymethyl cellulose, and combinations thereof, more preferably wherein said disintegrant is microcrystalline cellulose.

In a second aspect there is provided a method of forming the solid unit dose detergent composition according to the first aspect, the method comprising the following steps:
a) providing at least one lignosulphonate,
b) providing at least one disintegrant,
c) providing at least one detergent component,
d) admixing the at least one lignosulphonate and the at least one detergent component to form a detergent composition, and
e) compressing the detergent composition to form the solid unit dose detergent composition,
   wherein the at least one lignosulphonate is present in an amount of from 0.1 wt. % to 30 wt. %, based on the total weight of the detergent composition.

Preferably the at least one lignosulphonate is provided in an amount of from 0.1 wt. % to 10 wt. %, based on the total weight of the composition, more preferably 0.5 wt. % to 5 wt. %, even more preferably 1 wt. % to 3 wt. %.

Preferably the method further comprises adding a polar solvent to the composition in an amount of from 0.1 wt. % to 20 wt. % based on the total weight of the composition, preferably in an amount of from 0.5 wt. % to 5 wt. %.

Preferably the polar solvent is added to the composition after the addition of the lignosulphonate; in other words, after providing the at least one lignosulphonate.

Preferably the polar solvent is added to the composition by spraying the solvent onto the composition.

Preferably the polar solvent is a protic polar solvent, preferably wherein the polar solvent is selected from the group consisting of water, glycerol, polyethylene glycol, propylene glycol, dipropylene glycol and combinations thereof.

Preferably the solid unit dose detergent composition is in the form of a pill, tablet or briquette, or forms at least one layer or portion of a multilayer pill, tablet or briquette.

Preferably the detergent composition formed by the method according to the second aspect, comprises:
a source of alkalinity, preferably in an amount of from 1 wt. % to 80 wt. %, based on the total weight of the composition, preferably between 30 wt. % and 70 wt. %; and/or
a builder, preferably in an amount of from 0.1 wt. % to 20 wt. %, based on the total weight of the composition, preferably between 5 wt. % and 20 wt. %; and/or
a disintegrant in an amount of from 0.1 wt. % to 50 wt. %, based on the total weight of the composition; preferably between 4 wt. % and 40 wt. %, more preferably between 10 wt. % and 30 wt. %, even more preferably between 20 wt. % and 30 wt. %.

In a further aspect there is provided a use of lignosulphonate as a processing aid in a solid unit dose detergent composition.

In a further aspect there is provided a use of lignosulphonate as a processing aid in a solid unit dose detergent composition to improve the disintegration time of the composition.

The present disclosure will now be described further. In the following passages different aspects/embodiments of the disclosure are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

The present inventors have provided a new solid unit dose detergent composition comprising at least one lignosulphonate in an amount of from 0.1 wt. % to 30 wt. % based on the total weight of the composition, and a disintegrant.

The detergent composition of the present invention is a solid composition. Solid detergent compositions as well as liquid or gel detergent compositions are well-known in the art. It would be understood by the skilled person that solid detergent compositions may include components which are present as liquid phases without preventing their characterization as a solid detergent composition. In particular, solid detergent compositions may include processing aids, dyes, and fragrances each of which may be present as liquids and or solids.

It is known to formulate solid detergent formulations in various forms for example bulk forms such as powders or granulates and discrete forms such as tablets, briquettes and pills. As discussed above, formulating detergent compositions as discrete “unit dose” or “mono-dose” products has several advantages for the consumer. A unit dose detergent composition is designed to be used as a single portion of detergent composition in a single washing operation. Of course, one or more of such single portions may be used in a cleaning operation if desired and a detergent product may include multiple solid unit dose compositions.

Whilst liquid or gel compositions may require encapsulation in order to produce unit dose forms, it is well-known to compact or compress solid compositions in order to produce a unit dose form. For example, a powder may be pressed or stamped using a punch or compacted using rollers. The solid products produced by these methods have a variety of names often derived from the process of manufacture or shape of the product. Common pressed or compacted products include tablets, pills and briquettes.

The present inventors have surprisingly and unexpectedly found that the use of lignosulphonates allows for the production of a variety of such pressed or compacted products having advantageous properties without the use of solid polyethylene glycol binders or encapsulation.

It is also known to form such unit dose forms from a number of separate compositions which may have different effects in the cleaning process and physical properties, such as friability, disintegration rate and solubility. The composition of the present invention may be present as one or more compositions in a multi composition unit dose product. Preferably the solid unit dose detergent composition is in the form of a pill, tablet or briquette, or forms at least one layer or portion of a multilayer pill, tablet or briquette.

The use of separate layers or portions has the advantage of allowing incompatible ingredients of the overall formulation to be separated from each other, which can increase the stability of the overall composition. For example, bleach compounds and bleach sensitive ingredients such as colourants, perfumes and/or enzymes can be separated.

A known unit dose automatic dishwashing detergent product comprises a two-layer tablet and a pill provided in a recess on one surface of the tablet. The solid unit dose composition of the present invention may be the pill, the tablet or one of the layers of the tablet. In reference to this product the layers of the tables and the pill may each be considered as a solid unit dose composition.

The detergent composition of the present invention may be any type of detergent composition such as fabric detergent or hard surface detergent. Preferably, the detergent composition is an automatic dishwashing detergent composition or a laundry detergent composition, preferably wherein the composition is an automatic dishwashing detergent composition.

The composition of the present invention comprises at least one lignosulphonate. Lignosulphonates, or sulphonated lignin, are water-soluble anionic polyelectrolyte polymers. They are generally produced as by-products from the production of wood pulp. Lignin is part of wood and is one of the most abundant organic molecules on Earth. During pulping of wood, the lignin is sulfonated, the bonds between lignin and the polysaccharides as well as bonds within the lignin are broken, and the molecular weight of the lignin is reduced. As a result of the lignin from which they are produced, and indeed the method of their production, lignosulphonates exhibit structural variation. Lignosulphonate is a well-known term, and lignosulphonates have been used for almost 100 years as a plasticiser.

Preferably the at least one lignosulphonate is selected from the group consisting of ammonium lignosulphonate, sodium lignosulphonate, calcium lignosulphonate, magnesium lignosulphonate and combinations thereof. More preferably the at least one lignosulphonate is a sodium lignosulphonate. Sodium lignosulphonates have been found to be particularly suitable for use in detergent compositions due to their physical properties.

The at least one lignosulphonate is preferably derived from a sulphite pulping process, in which sulphur dioxide and/or bisulphite ions react with lignin to produce water-soluble sulphonated lignins that are degraded by acid hydrolysis reactions. Preferably, the at least one lignosulphonate has a molecular weight distribution, in which at least 50% of the lignosulphonate has a molecular weight between 1000 g/mol and 12500 g/mol, preferably at least 60%, more preferably at least 65%, and/or a degree of sulphonation of between 0.25 mmol/g and 1 mmol/g, preferably between 0.5 mmol/g and 0.75 mmol/g, even more preferably between 0.6 and 0.65 mmol/g. The skilled person will understand that the degree of sulphonation is defined as the millimolar content of sulphonic acid per gram of lignosulphonate. This parameter may affect properties of lignosulphonates such as water solubility, dispersing performance, surface activity, and complexation activity.

Preferably the lignosulphonate is present in an amount of from 0.1 wt. % to 10 wt. %, preferably 0.5 wt. % to 5 wt. %, preferably 1 wt. % to 3 wt. %, based on the total weight of the composition. Use of lignosulphonates in these amounts has been found to provide solid unit dose detergent compositions (such are pills and tablets) having acceptable friability and disintegration rates without requiring the use of solid polyethyleneglycol (PEG).

Advantageously, the solid unit dose detergent compositions of the present invention have low friability and low disintegration time. Without wishing to be bound to any theory, it is believed that the use of lignosulphonates in the compositions, together with the disintegrant, improves both the friability and the disintegration time of the solid unit dose detergent compositions of the invention. In particular, the solid unit dose detergent compositions of the invention have been found to have equivalent or even improved disintegration rates to equivalent compositions using solid PEG.

Solid PEG will be understood to mean a polyethylene glycol which is solid at room temperature and pressure. Solid PEGs are often used as binders or additives in solid detergent products but, as discussed above, are expensive and not sustainable as these are petroleum based. Preferably the compositions of the present invention are free of solid PEG.

Liquid PEG, that is PEG which is liquid at room temperature and pressure, may be used as solvents at various stages in the production of the detergent compositions of the present invention.

By room temperature and pressure, it will be understood a temperature of between 20° and 25 °C and 1 atm pressure.

Preferably the composition comprises the disintegrant in an amount of from 0.1 wt. % to 50 wt. %, based on the total weight of the composition, preferably in an amount between 4 wt. % to 40 wt. %, more preferably between 10 wt. % and 30 wt. %, even more preferably between 20 wt. % and 30 wt. %. Disintegrants expand and/or dissolve when wet causing the solid article to collapse. They are used to ensure that when the solid article contacts water, such as in a wash cycle, it rapidly breaks down into smaller fragments thereby facilitating dissolution.

The disintegrant may be selected from the group consisting of cellulose, in particular microcrystalline cellulose, and crosslinked polymers including polyvinylpyrrolidone and carboxymethyl cellulose. Preferably, the disintegrant is microcrystalline cellulose.

Microcrystalline cellulose is a partially depolymerised cellulose synthesised from α-cellulose precursor.

The detergent compositions of the invention may include further components known in conventional detergent formulations. As will be understood, the specific further components and amounts will depend on the specific type of detergent composition.

In particular the detergent composition may include one or more of bleaches, bleach activators, bleach catalysts, builders, sulphonated polymers, surfactants, enzymes, sources of alkalinity or acidity, anti-corrosion agents, foam control agents, preservatives, dyes, colorants and perfumes/fragrances.

### Bleaching Components

According to one embodiment, the detergent compositions of the invention further contains at least one percarbonate and/or persulphate. The sodium and potassium salts of percarbonate and persulphate are preferred, especially the sodium salts. Mixtures of percarbonate and persulphate bleach may be used if desired.

The percarbonate or persulphate bleach may optionally be encapsulated/coated with any suitable material.

According to one aspect of the invention, the detergent compositions preferably comprise at least one organic peracid bleach, preferably a perbenzoic acid and/or a peroxycarboxylic acid in addition to the claimed lignosulphonate.

Preferably the peroxycarboxylic acid comprises monoperoxyphthalic acid, diperoxyphthalic acid, 2-octyldiperoxysuccinic acid, diperoxydodecanedicarboxylic acid, diperoxyazelaic acid, imidoperoxycarboxylic acid or phthalimidoperoxyhexanoic acid including derivatives and salts thereof and mixtures thereof. Especially preferred is phthalimidoperoxyhexanoic acid (PAP) and derivatives and salts thereof.

The organic peracid may optionally be encapsulated/coated with any suitable material.

The detergent compositions of the invention may comprise additional bleaching compounds. Any type of additional bleaching compound conventionally used in detergent compositions may be used.

This additional bleaching compound preferably comprises at least one inorganic peroxide or a chlorine-based bleach including derivatives and salts thereof or mixtures thereof but excluding the percarbonate, persulphate and organic peracid bleaches mentioned above. Preferably the at least one inorganic peroxide comprises a perborate and/or hydrogen peroxide including derivatives and salts thereof and mixtures thereof. The sodium and potassium salts of these inorganic peroxides being most preferred, especially the sodium salts.

When the compositions comprise a bleach, in particular a percarbonate or persulphate bleach, they may preferably comprise one or more bleach activators or bleach catalysts depending upon the nature of the bleaching compound. Any suitable bleach activator may be included for example TAED. Any suitable bleach catalyst may be used for example manganese acetate, manganese oxalate or dinuclear manganese complexes such as those described in EP-A-1,741,774.

### Builders

The detergent compositions may further comprise one or more aminocarboxylate builders. Mixtures of such compounds may also be used.

Preferred examples of aminocarboxylate builders for use in the compositions of the present invention include MGDA (methyl-glycine-diacetic acid, and salts and derivatives thereof) and GLDA (glutamic-N,N-diacetic acid and salts and derivatives thereof) and mixtures of MGDA and GLDA.

Other suitable builders are described in U.S. Pat. No. 6,426,229 and are incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl) aspartic acid (SMAS), N-(2-sulfoethyl)aspartic acid (SEAS), N-(2-sulfomethyl)glutamic acid (SMGL), N-(2-sul-foethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), an-thranilic acid-N,N-diacetic acid (ANDA), sulfanilic acid-N,N-diacetic acid (SLDA), taurine-N, N-diacetic acid (TUDA) and sulfomethyl-N,N-diacetic acid (SMDA) and alkali metal salts or ammonium salts thereof.

One class of phosphorous-containing builders are phosphates, in particular mono-phosphates, di-phosphates, tri-polyphosphates or oligomeric-poylphosphates are used. The alkali metal salts of these compounds are preferred, in particular the sodium salts. An especially preferred builder is sodium tripolyphosphate (STPP). Some preferred embodiments are phosphate free.

Another class of phosphorus-containing builders are phosphonic acids, a particularly preferred phosphonic acid is HEDP 1-hydroxyethane 1,1-diphosphonic acid. In some embodiments the composition comprises HEDP.

For phosphorous-free builders suitable examples include succinate-based builders. The terms ‘succinate-based compound’ and ‘succinic acid based compound’ are used interchangeably herein. Preferred succinate compounds are described in U.S. Pat. No. 5,977,053 and have the formula;

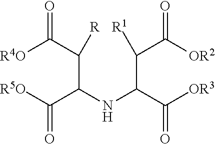

in which R, R¹, independently of one another, denote H or OH, R², R³, R⁴, R⁵, independently of one another, denote a cation, hydrogen, alkali metal ions and ammonium ions, ammonium ions having the general formula R⁶ R⁷ R⁸ R⁹ N+ and R⁶, R⁷, R⁸, R⁹, independently of one another, denoting hydrogen, alkyl radicals having 1 to 12 C atoms or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate-based builder salts.

The phosphorous-free builder may also or alternatively comprise non-polymeric organic molecules with carboxylic group(s). Builder compounds which are organic molecules containing carboxylic groups include citric acid, fumaric acid, tartaric acid, maleic acid, lactic acid and salts thereof. Suitable builders include polycarboxylate builders which are molecules containing multiple carboxyl groups. Such polycarboxylates which comprise two carboxyl groups include, for example, water-soluble salts of, malonic acid, (ethylenedioxy) diacetic acid, maleic acid, diglycolic acid, tartaric acid, tartronic acid and fumaric acid. Such polycarboxylates which contain three carboxyl groups include, for example, water-soluble citrate.

Correspondingly, a suitable hydroxycarboxylic acid is, for example, citric acid. In particular the alkali or alkaline earth metal salts of these organic compounds may be used, and especially the sodium salts. An especially preferred phosphorous-free builder is sodium citrate, preferably trisodium citrate.

The actual amount of various builders used in the compositions will depend upon the nature of the builder used and the type of composition. If desired a combination of phosphorous-containing and phosphorous-free builders may be used.

The composition may comprise a builder, preferably in an amount of from 0.1 wt. % to 20 wt. %, based on the total weight of the composition, preferably between 5 wt. % and 20 wt. %.

### Sulphonated Polymers

Preferred examples of the sulphonated polymers include copolymers of CH₂═CR¹—CR²R³—O—C₄H₃R⁴—SO₃X wherein R¹, R², R³, R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methally-sulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water-soluble salts thereof. Suitable sulphonated polymers are also described in U.S. Pat. No. 5,308,532 and in WO 2005/090541.

It is especially preferred that the sulphonated polymer comprises monomers of a carboxylic acid and a sulphonated monomer, especially acrylic acid and/or 2-acrylamido-2-methyl-1-propanesulphonic acid (AMPS). It is most preferred that the sulphonated polymer is a copolymer of acrylic acid and AMPS, especially in a weight ratio (of the monomers of 50:50 to 90:10, such as 70:30 to 80:20.

### Surfactants

In addition to the ingredients specified above the compositions of the invention may further comprise one or more surfactants to aid with cleansing.

If a surfactant is present it may be any of non-ionic, anionic, cationic, amphoteric or zwitterionic surface active agents or mixtures thereof. Many such suitable surfactants are described in Kirk Othmer's Encyclopedia of Chemical Technology, 3rd Ed., Vol. 22, pp. 360-379, “Surfactants and Detersive Systems”, incorporated by reference herein. In some embodiments, bleach-stable surfactants are preferred according to the present invention.

For automatic dishwashing compositions according to the present invention non-ionic surfactants are especially preferred. For laundry and other cleaning applications other surfactants such as anionic surfactants are preferably included, and suitable types are well known in the art.

A preferred class of non-ionic surfactants is ethoxylated non-ionic surfactants prepared by the reaction of a monohydroxy alkanol or alkylphenol with 6 to 20 carbon atoms. Preferably the surfactants have at least 12 moles particularly preferred at least 16 moles, and still more preferred at least 20 moles, such as at least 25 moles of ethylene oxide per mole of alcohol or alkylphenol.

Particularly preferred non-ionic surfactants are the non-ionics formed from a linear chain fatty alcohol with 16-20 carbon atoms and at least 12 moles, particularly preferred at least 16 and still more preferred at least 20 moles, of ethylene oxide per mole of alcohol.

According to one embodiment of the invention, the non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols or alkylphenols, which additionally comprises polyoxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and polyoxypropylene and block copolymers of polyoxyethylene and polyoxypropylene initiated with trimethylolpropane.

Another preferred class of non-ionic surfactant can be described by the formula:

R¹O[CH₂CH(CH₃)O]_{X}[CH₂CH₂O]_{Y}[CH²CH(OH)R²]

where R¹ represents a linear or branched chain aliphatic hydrocarbon group with 4-18 carbon atoms or mixtures thereof, R² represents a linear or branched chain aliphatic hydrocarbon rest with 2-26 carbon atoms or mixtures thereof, x is a value between 0.5 and 1.5 and y is a value of at least 15.

Another group of preferred non-ionic surfactants are the end-capped polyoxyalkylated non-ionics of formula:

R¹O[CH₂CH(R³)O]_{X}[CH₂]ₖCH(OH)[CH₂]ⱼOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R³ in the formula above can be different. R¹ and R² are preferably linear or branched chain, saturated or unsaturated, aliphatic or aromatic hydrocarbon groups with 6-22 carbon atoms, where groups with 8 to 18 carbon atoms are particularly preferred. For the group R³ H, methyl or ethyl is particularly preferred. Particularly preferred values for x are comprised between 1 and 20, preferably between 6 and 15.

As described above, in case x>2, each R³ in the formula can be different. For instance, when x=3, the group R³ could be chosen to build ethylene oxide (R³═H) or propylene oxide (R³=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R¹O[CH₂CH(R³)O]_{X}CH₂CH(OH)CH₂OR²

The use of mixtures of different non-ionic surfactants is suitable in the context of the present invention for instance mixtures of alkoxylated alcohols and hydroxy groups containing alkoxylated alcohols.

Other suitable surfactants are disclosed in WO 95/01416, to the contents of which express reference is hereby made.

### Enzymes

Any type of enzyme typically used in detergent compositions may be included in the compositions of the present invention. It is preferred that the enzyme is selected from other proteases, lipases, amylases, cellulases and peroxidases, with other proteases and amylases being most preferred. It is most preferred that protease and/or amylase enzymes are included in the compositions according to the invention as such enzymes are especially effective for example in dishwashing detergent compositions. Any suitable species of these enzymes may be used as desired. Conventional amounts of such enzymes may be used.

### Source of Acidity or Alkalinity

The compositions according to the invention may also comprise a source of acidity or a source of alkalinity, to obtain the desired pH, on dissolution, especially if the composition is to be used in an automatic dishwashing application. Preferred silicates are sodium silicates such as sodium disilicate, sodium metasilicate and crystalline phyllosilicates. A source of acidity may suitably be any suitable acidic compound for example a polycarboxylic acid. For example, a source of alkalinity may be a carbonate or bicarbonate (such as the alkali metal or alkaline earth metal salts). In some embodiments, the source of acidity and the disintegrant are different compounds. A source of alkalinity may suitably be any suitable basic compound for example any salt of a strong base and a weak acid. When an alkaline composition is desired silicates are amongst the suitable sources of alkalinity. Conventional amounts of the alkalinity or acidity source may be used.

The composition may comprise a source of alkalinity, preferably in an amount of from 1 wt. % to 80 wt. %, based on the total weight of the composition, preferably between 30 wt. % and 70 wt. %. In some embodiments, the source of alkalinity and the disintegrant are different compounds.

### Anti-Corrosion Agent

The detergent compositions may comprise one or more anti-corrosion agents, especially when the detergent compositions are for use in automatic dishwashing operations. These anti-corrosion agents may provide benefits against corrosion of glass and/or metal and the term encompasses agents that are intended to prevent or reduce the tarnishing of non-ferrous metals, in particular of silver and copper. In many detergent compositions according to the present invention it may be desirable to include more than one type of anti-corrosion agent to provide protection against corrosion of glass and metals.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, bismuth, manganese, titanium, zirconium, hafnium, vanadium, cobalt and cerium salts and/or complexes, the metals being in one of the oxidation states II, III, IV, V or VI. Particularly suitable metal salts and/or metal complexes are chosen from the group consisting of MnSO4, Mn(II) citrate, Mn(II) stearate, Mn(II) acetylacetonate, Mn(II) [1-hydroxyethane-1,1-diphosphonate], V2O5, V2O4, VO2, TiOSO4, K2TiF6, K2ZrF6, CoSO4, Co(NO3)2 and Ce(NO3)3. Any suitable source of multivalent ions may be used, with the source preferably being chosen from sulphates, carbonates, acetates, gluconates and metal-protein compounds. Zinc salts are specially preferred corrosion inhibitors.

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C1 to C20 alkyl groups and hydroxyl, thio, phenyl or halogen such as fluorine, chlorine, bromine and iodine. A preferred substituted benzotriazole is tolyltriazole.

Therefore, an especially preferred optional ingredient according to the present invention is a source of multivalent ions such as those mentioned in the immediately preceding paragraphs and in particular compounds comprising zinc, bismuth and/or manganese ions and/or benzotriazole, including substituted benzotriazoles. In particular a source of zinc ions and unsubstituted benzotriazole are preferred as anti-corrosion agents and a mixture of these two ingredients is especially preferred according to the invention.

Any conventional amount of the anti-corrosion agents may be included in the solid detergent compositions of the invention.

### Foam Control Agent

The detergent composition may also comprise one or more foam control agents. Suitable foam control agents for this purpose are all those conventionally used in this field, such as, for example, silicones and their derivatives and paraffin oil.

### Lubricants

The detergents composition may include one or more lubricants or release agents. Suitable release agents include stearates, preferably magnesium stearate.

The detergent compositions of the invention may also comprise minor, conventional, amounts of preservatives, lubricants, dyes, and perfume/fragrance as desired.

In a preferred embodiment, the solid unit dose detergent composition comprises, based on the total weight of the composition:
0.1 wt. % to 20 wt. % of a builder;
1 wt. % to 80 wt. % of a source of alkalinity;
0.1 wt. % to 30 wt. % of at least one lignosulphonate; and
0.1 wt. % to 50 wt. % of a disintegrant.

In a more preferred embodiment, the solid unit dose detergent composition comprises, based on the total weight of the composition:
5 wt. % to 20 wt. % of a builder;
30 wt. % to 70 wt. % of a source of alkalinity;
0.1 wt. % to 10 wt. % of at least one lignosulphonate; and
20 wt. % to 30 wt. % of a disintegrant.

In a preferred embodiment, the solid unit dose detergent composition comprises, based on the total weight of the composition:
5 wt. % to 20 wt. % of one or more builders;
30 wt. % to 70 wt. % of one or more sources of alkalinity;
1 wt. % to 3 wt. % lignosulphonate;
0.01 wt. % to 10 wt. % of one or more enzymes;
0.01 wt. % to 0.5 wt. % of one or more dyes;
0.01 wt. % to 0.5 wt. % lubricant; and
20 wt. % to 30 wt. % of one or more disintegrants, preferably cellulose, more preferably microcrystalline cellulose.

The above composition may be combined with one or more further unit dose compositions to provide a detergent product, preferably an automatic dishwashing detergent product.

In a second aspect there is provided a method of forming the solid unit dose detergent composition according to the first aspect, the method comprising:
a) providing lignosulphonate,
b) providing at least one disintegrant
c) providing at least one detergent component,
d) admixing the lignosulphonate and the at least one detergent component to form a detergent composition, and
e) compressing the detergent composition to form the solid unit dose detergent composition,
   wherein the lignosulphonate is present in an amount of from 0.1 wt. % to 30 wt. %, based on the total weight of the detergent composition.

Preferably lignosulphonate is provided in an amount of from 0.1 wt. % to 10 wt. %, based on the total weight of the composition, preferably 0.5 wt. % to 5 wt. %, more preferably 1 wt. % to 3 wt. %.

The step of compressing the detergent composition to form the solid unit dose detergent composition may comprise any known technique including piston presses, screw compaction or extrusion, pan grinder press and roller press.

In a particularly preferred embodiment, the solid unit dose detergent composition is a pill, and the compressing step comprises compressing the lignosulphonate containing composition using a piston press to produce said pills.

In some embodiments the method further comprises adding a polar solvent in an amount of from 0.1 wt. % to 20 wt. % based on the total weight of the composition, preferably in an amount of from 0.5 wt. % to 5 wt. %. These amounts of solvent may be useful in improving the stability of the solid unit dose detergent compositions produced. Where a solvent is used the process may optionally further comprise a drying step. The temperature and duration of the drying step may be used to tune the properties, such as friability and hardness, of the solid unit dose detergent composition produced.

In some embodiments no solvent is added.

Where a solvent is used, it is either added after the addition of lignosulphonate and it may be applied to the composition by spraying or is added with the lignosulphonate solution or dispersion. Preferably the solvent is added after the addition of lignosulphonate.

Solvents may in general be characterized as polar or non-polar. Polar solvents may be defined as solvents having a dielectric constant of greater than 15. Polar solvents may be further characterized as either protic or aprotic polar solvents. Protic solvents can strongly solvate anions via hydrogen bonding. Aprotic solvents may solvate cations via their negative dipole.

The polar solvent may be a protic polar solvent, preferably wherein the polar solvent is selected from the group consisting of water, glycerol, polyethylene glycol, propylene glycol, dipropylene glycol, and combinations thereof. If a PEG solvent is used it is liquid at room temperature and pressure and is therefore a liquid PEG.

Preferably the solid unit dose detergent composition is in the form of a pill, tablet or briquette, or forms at least one layer or portion of a multilayer pill, tablet or briquette.

The specific components of the detergent composition of the method are as described above in respect to the first aspect. That is, the at least one detergent component may be any of the components of the detergent composition of the first aspect discussed above. The at least one detergent component may be bleaches, bleach activators, builders, sulphonated polymer, organophosphoric acid, surfactants, enzymes, sources of alkalinity or acidity, anti-corrosion agents, foam control agents, preservatives, dyes, and perfumes/fragrances. Preferably combinations of two or more of these components are combined with the lignosulphonate. Preferably combinations of components are provided in order to produce compositions as discussed above in respect of the first aspect.

The present inventors have surprisingly found that lignosulphonates may be used in solid unit dose detergent compositions as a processing aid. In particular, the present inventors have surprisingly found that lignosulphonates may be used in solid unit dose detergent compositions as a processing aid to improve (reduce) disintegration time of solid unit dose detergent compositions whilst maintaining the cleaning performance and physical properties of the unit dose compositions. Advantageously, the use of lignosulphonates may allow for solid PEG to be eliminated from said compositions.

### Test Methods

### Disintegration Time Test Procedure

The disintegration time is measured using a Disintegration-Tester Erweka ZT 54, with the water bath of the Disintegration Tester set to 40 °C. Then, a 1 litre beaker is filled with 800 ml of 40 °C tap water. Three samples in the form of a pill of about 1.2 g each are then placed in a three-chamber basket, which is subsequently repeatedly dipped into the water-filled beaker. The time on the Disintegration Tester is checked at regular intervals and recorded once each sample has disappeared from the basket.

### Friability Test Method

The friability of the samples was measured using an Erweka friability machine. A set number of samples, depending on the format, are weighed. For the pill, this is 20 samples. The samples are then placed in the drum of the machine and the machine is set to rotate at 20-25 RPM for 4 min. The samples are then weighed again, and the friability is calculated as the percentage difference between the two measurements.

### Hardness Test Method

Hardness is measured using an Erweka TBH30 Hardness tester. In this device hardness is measured by a strain gauge which is incorporated into the load cell. The force exerted by a sample (for example a pill or a tablet) on the load cell prior to braking causes the strain gauge to deform thus creating a change in itrs resistance which is then subsequently measured. The feed speed of the test jaw is adjusted to 0.5 mm/s.

### EXAMPLES

The present invention will now be described further with reference to the following non-limiting examples.

### Example 1

Formulations according to the invention and not according to the invention were prepared. Their composition is shown in table 1. It should be noted that the ingredients used in all compositions were the same, except for the binder.

The following example demonstrates that lignosulphonate may be used as a replacement for solid PEG in a detergent composition without adversely affecting the physical properties of the solid unit dose detergent composition produced therefrom.

TABLE 1
Compositions

Composition (wt. %)

| Ingredient | A | B | 1 |
|---|---|---|---|
| Source of alkalinity | 51 | 51 | 55.3 |
| Enzyme | 7.5 | 7.5 | 7.5 |
| Polyethylene Glycol - Solid | 0 | 5.3 | 0 |
| Lignosulphonate | 0 | 0 | 1 |
| Builder | 11.5 | 11.5 | 11.5 |
| Disintegrant | 24.7 | 24.7 | 24.7 |
| Others* | q.s. | q.s. | q.s. |

*Others: surfactant, lubricant, disintegrant, dye, and/or perfume.
The disintegrant in Table 1 is microcrystalline cellulose.

The compositions shown in Table 1 were tested for friability and disintegration time at varying levels of aging. Firstly, the base detergent formulation (Formulation A) was tested as a comparative example, as a benchmark the base formulation with 5.3% solid PEG (Formulation B) was tested, and finally an inventive composition comprising the base formulation and 1 wt. % lignosulphonate (Formulation 1) was tested. The mass of the formulations was equal across the three tests.

The compositions were tested for friability and disintegration time at 40 °C after the following aging conditions:
Initial or as-produced state;
After 1 week of aging at 50 °C and 25% relative humidity;
After 6 weeks aging at 40 °C and 75% relative humidity; and
After 6 weeks aging at 30 °C and 65% relative humidity.

The friability and disintegration tests were performed using the procedures described above.

The results provided in Table 2 show that all three compositions produced acceptable pills in terms of both friability and disintegration time. However, the Benchmark (Composition B) containing pill showed increased friability after both of the 6-week aging regimes. The inventive composition (Composition 1) and the base detergent formulation (Composition A) showed acceptable friability under all conditions.

The comparative examples (Compositions A and B) showed acceptable disintegration as-produced but under all three ageing regimes showed poor increased disintegration times. Both the benchmark (Composition B) and the inventive composition (Composition 1) showed slightly increased disintegration time under the high temperature ageing but otherwise performed well.

These results clearly show that the lignosulphonates allow for the production of solid unit dose detergent compositions at least equivalent and in some cases improved friability and disintegration times when compared with conventional PEG containing formulations.

### Example 2

The potential use of various polar solvents was determined by preparing four formulations comprising different solvents. The solvent (water, glycerol, PEG 400, or propylene glycol) was added in the end, after all other ingredients had been mixed. The compositions of the formulations that were prepared are shown in table 3. It should be noted that the ingredients used in all compositions were the same, except for the binder.

In each of the lignosulphonate containing compositions the solid PEG of a commercial formulation was replaced with lignosulphonate and solvent as shown.

TABLE 3
Compositions comprising different polar solvents.

Composition (wt. %)

| Ingredient | 2 | 3 | 4 | 5 |
|---|---|---|---|---|
| Source of Alkalinity | 50 | 50 | 50 | 50 |
| Enzyme | 7.5 | 7.5 | 7.5 | 7.5 |
| Lignosulphonate | 2 | 2 | 2 | 2 |
| Water | 1 | 0 | 0 | 0 |
| Glycerol | 0 | 1 | 0 | 0 |
| PEG 400 | 0 | 0 | 1 | 0 |
| Propylene glycol | 0 | 0 | 0 | 1 |
| Builder | 11.5 | 11.5 | 11.5 | 11.5 |
| Disintegrant | 24.7 | 24.7 | 24.7 | 24.7 |
| Others* | q.s. | q.s. | q.s. | q.s. |

*Others: surfactant, lubricant, disintegrant, dye, and/or perfume

TABLE 4
Hardness, friability, and disintegration tests of
compositions comprising different polar solvents

| | Hardness | Friability | Disintegration Time@ |
|---|---|---|---|
| Composition | (N) | (%) | 40 °C (mm:ss) |
| 2 | 85 | 1.15 | 02:10 |
| 3 | 79 | 0.8 | 03:03 |
| 4 | 71 | 1.17 | 02:17 |
| 5 | 96 | 0.49 | 02:31 |

The hardness, friability and disintegration tests were performed using the procedures described above.

The results in table 4 show that a range of polar solvent may be used to produce solid unit dose detergent compositions of the invention. The inventors have also found that an optional drying step may be included to tune the physical properties of the solid unit dose detergent compositions produced. Specifically, the hardness and friability may be reduced by performing a drying step.

The foregoing Examples have been provided by way of explanation and illustration and are not intended to limit the scope of the appended claims. Many variations in the presently preferred embodiments illustrated herein will be apparent to one of ordinary skill in the art and remain within the scope of the appended claims and their equivalents.

1. A solid unit dose detergent composition comprising 0.1 wt. % to 30 wt. % of at least one lignosulphonate, based on the total weight of the composition, and a disintegrant.

2. The detergent composition of claim 1, wherein the composition is an automatic dishwashing detergent or a laundry detergent.

3. The detergent composition of claim 1, wherein the at least one lignosulphonate is selected from the group consisting of ammonium lignosulphonate, sodium lignosulphonate, calcium lignosulphonate, magnesium lignosulphonate and combinations thereof.

4. The detergent composition of claim 1, wherein the lignosulphonate is present in an amount of from 0.1 wt. % to 10 wt. %, based on the total weight of the composition.

5. The detergent composition of claim 1, further comprising:
a source of alkalinity.

6. The detergent composition of claim 1, wherein the composition comprises the disintegrant in an amount of from 0.1 wt. % to 50 wt. % based on the total weight of the total composition.

7. The detergent composition of claim 1, wherein the composition comprises, based on the total weight of the composition:
5 wt. % to 20 wt. % of a builder;
30 wt. % to 70 wt. % of a source of alkalinity;
0.1 wt. % to 10 wt. % of the at least one lignosulphonate; and
20 wt. % to 30 wt. % of the disintegrant.

8. A method of forming the solid unit dose detergent composition according to claim 1, the method comprising:
a) providing at least one lignosulphonate,
b) providing at least one disintegrant,
c) providing at least one detergent component,
d) admixing the at least one lignosulphonate and the at least one detergent component to form a detergent composition, and
e) compressing the detergent composition to form the solid unit dose detergent composition,
wherein the at least one lignosulphonate is present in an amount of from 0.1 wt. % to 30 wt. %, based on the total weight of the detergent composition.

9. The method of claim 8, wherein lignosulphonate is provided in an amount of from 0.1 wt. % to 10 wt. %, based on the total weight of the composition.

10. The method of claim 8, further comprising adding a polar solvent to the composition in an amount of from 0.1 wt. % to 20 wt. %, based on the total weight of the composition.

11. The method of claim 10, wherein the polar solvent is added to the composition after the addition of the lignosulphonate and/or wherein the polar solvent is added to the composition by spraying the solvent onto the composition.

12. The method of claim 10, wherein the polar solvent is a protic polar solvent.

13. The detergent composition of claim 1, or the method of claim 8, wherein the solid unit dose detergent composition is in the form of a pill, tablet or briquette, or forms at least one layer or portion of a multilayer pill, tablet or briquette.

14. The method of claim 8, wherein the detergent composition comprises:
a source of alkalinity; and/or
a builder; and/or
a disintegrant in an amount of from 0.1 wt. % to 50 wt. %, based on the total weight of the composition.

15. (canceled)

16. The detergent composition of claim 5, wherein the source of alkalinity is present in an amount of from 1 wt. % to 80 wt. %, based on the total weight of the composition.

17. The detergent composition of claim 6, wherein said disintegrant is selected from the group consisting of cellulose, crosslinked polymers including polyvinylpyrrolidone and carboxymethyl cellulose, microcrystalline cellulose and combinations thereof.

18. The method of claim 12, wherein the polar solvent is selected from the group consisting of water, glycerol, polyethylene glycol, propylene glycol, dipropylene glycol, and combinations thereof.

19. A method of improving the disintegration time of a solid unit dose detergent composition, comprising the step of including lignosulphonate in said solid unit dose detergent composition.
